(19) United States
(12) Patent Application Publication
(10) Pub. No.: US 2016/0011616 A1
(43) Pub. Date: Jan. 14, 2016

(54) POWER MANAGEMENT

(71) Applicant: Microsoft Technology Licensing, LLC, Redmond, WA (US)

(72) Inventors: Brian JANOUS, Issaquah, WA (US); Gregory Joseph MCKNIGHT, Bellevue, WA (US); David GAUTHIER, Seattle, WA (US)

(73) Assignee: MICROSOFT TECHNOLOGY LICENSING, LLC, Redmond, WA (US)

(21) Appl. No.: 14/673,759

(22) Filed: Mar. 30, 2015

Related U.S. Application Data
(60) Provisional application No. 62/023,707, filed on Jul. 11, 2014.

(51) Int. Cl. G05F 1/66; G05B 15/02; H02J 3/00

(52) U.S. Cl. CPC G05F 1/66; H02J 3/00; G05B 15/02

(57) ABSTRACT

The description relates to smart energy usage. One example can obtain market information relating to power available to a consumer device and can obtain operational information relating to use of the consumer device. The example can also determine when to operate the device based upon the market information and the operational information.

### PRIORITY

This application is a utility application that claims priority from provisional application 62/023,707 filed Jul. 11, 2014, which is incorporated by reference in its entirety.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the FIG. and associated discussion where the reference number is first introduced.

FIGS. 1-3 show example systems in accordance with some implementations of the present concepts.

FIGS. 4-6 show example flowcharts in accordance with some implementations of the present concepts.

### DETAILED DESCRIPTION

### Overview

This patent relates to enabling energy aware device operation of consumer devices. In this document the terms ‘energy’ and ‘power’ are used interchangeably. As used herein, energy-aware device operation can consider, energy-related parameters, such as supply side factors, power cost, power quality, carbon emissions, and/or power source (e.g., what kind of power generator produced the power and/or what percentage of the power is from renewable versus non-renewable sources). The energy-aware device operation of consumer devices can be accomplished in a manner that is advantageous to both energy producers and energy consumers.

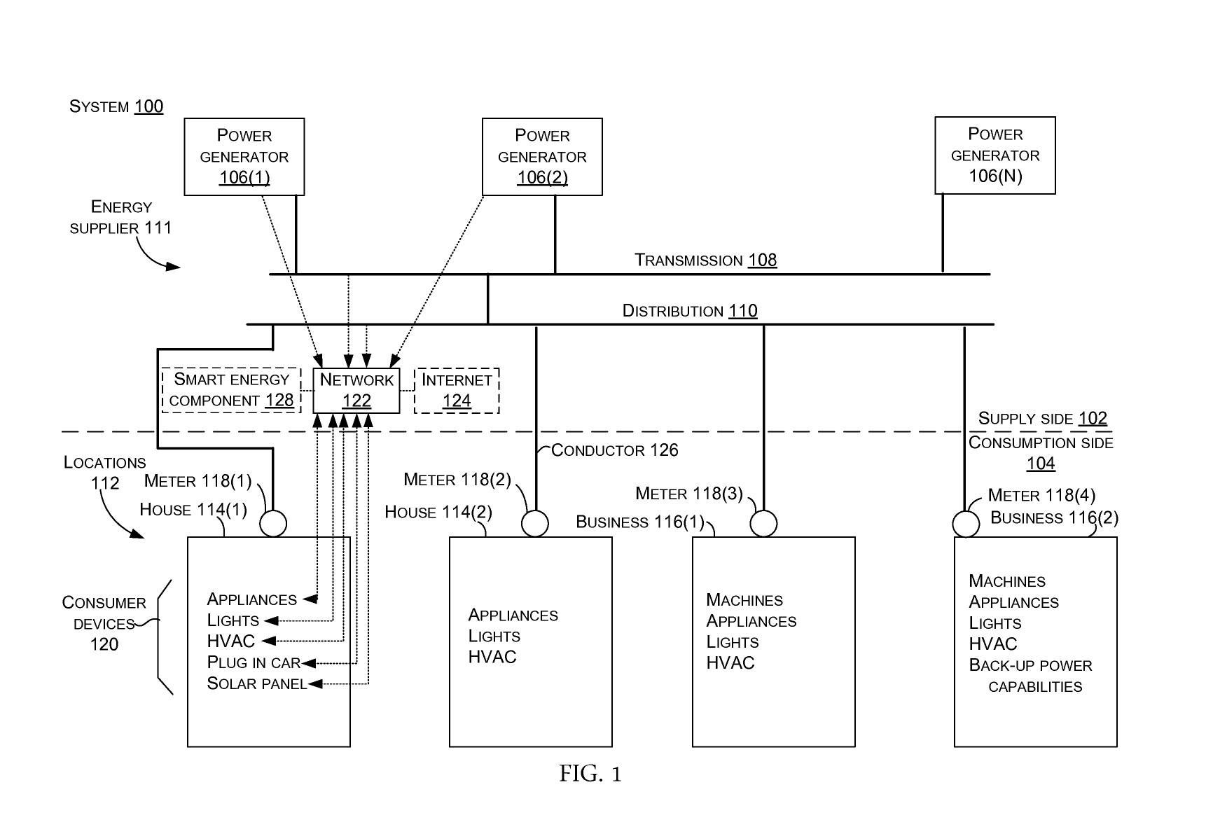

Introductory FIG. 1 shows a system 100 that is divided generally into a supply side 102 and a consumption side 104. The supply side 102 can include power generators 106, such as fossil fuel powered plants, nuclear plants, hydroelectric dams, solar, wind, geothermal, tidal, etc. Power generators tend to be connected to transmission lines 108 which are connected to distribution lines 110. The distribution lines tend to be managed by utilities. Supply side entities, such as power generators 106, grid managers, and/or utilities, among others can be generally referred to as energy suppliers 111. Eventually, the utilities can supply the power from the distribution lines 110 to physical locations 112 on the consumption side 104, such as houses 114 and/or businesses 116. Often the power utilized at a location, such as a home is routed through a meter 118 which can track power usage at the location. The power can be consumed by various consumer devices 120, such as appliances, lights, HVAC systems, various machines, electric or hybrid cars, etc. These devices can be thought of as consumer devices since they are on the consumption side. For instance, a home owner's refrigerator can be thought of as a consumer device and so can servers at a data center operated by a corporation.

Note that the division between supply and consumption is generally accurate, but not in all cases. For instance, some consumer devices 120 on the consumption side may be able to produce and/or store power that could be supplied to the grid. For example, an individual location, such as a house or business may have a solar panel or wind turbine, and/or back up capabilities, such as a battery bank and a generator and/or fuel cell. Thus, some consumer devices 120 on the consumption side 104 can generate power that can be used at the location and/or can be delivered back to the supply side 102. The present concepts can be applied to these consumer devices 120 that can generate and/or store power as well as consumer devices that consume power.

The present concepts can allow the flow of energy-related information between energy consumers and energy suppliers. This flow of energy-related information can be end-to-end or more limited. In an end-to-end scenario, communications can occur between a supply side entity, such as a distributer, and an individual consumer device 120 at a location 112. The communications can occur via one or more networks 122. Some of these networks can provide access to the Internet 124. Example networks can be wired or wireless. In the case of wired networks, conductors (e.g., wires) 126 that supply the power to the locations 112 can also convey information or different conductors such as fiber optic conductors can be employed. In some cases, the communications can be facilitated by smart energy components 128. The smart energy components 128 can occur at individual entities, such as utilities, grid operators, and/or power generators 106 on the supply side 102, individual consumer devices 120 on the consumption side 104, and/or at remote locations, such as on cloud-based resources. Note that while this communication may include communication with the associated meter 118, the communication goes farther and can include or relate to an individual consumer device on the customer (e.g., consumer) side of the meter.

In some cases, the smart energy components 128 can enable individual devices, such as supply side devices, network devices, and/or consumer device 120 to make operational decisions for the user based upon the energy-related information including supply side parameters or information and/or consumption side parameters or information. These decisions can be made with passive information and/or express user information. An example of passive information can relate to usage patterns, such as the user does not take clothes out of the clothes dryer between 10:00 P.M. and 6:00 A.M. or that the user leaves for work at 7:00 A.M. and needs the batteries on his/her battery powered car to be charged at that time. Similarly, the user may expressly state, such as via a graphical user interface that the user does not plan to be home until 5:00 P.M. on days that he/she leaves at 7:00 A.M. and wants the dishwasher to run during the day at a time when the power is the cheapest or when the percentage of renewable power is the highest, etc. The present implementations can allow these individual devices to use power consistent with the learned and/or express information. The energy-related information can also include information from the devices themselves, such as how long a wash cycle for the dishwasher takes and how much power it uses at different points in the wash cycle.

In some cases, the consumer devices 120, (or a smart energy component 128 acting on their behalf) can obtain energy-related information from the Internet 124. This energy-related information can include energy supply related information such as real time pricing information, estimated pricing information (e.g., hourly pricing for the next 24 hours), renewable contribution (e.g. a renewable composition profile), etc. for the supplier of power to the user (e.g., to the meter). As such, the energy supply related information can be thought of as market information. Thus, continuing with the above examples, the smart energy component may obtain an hourly power cost projection that shows the lowest power rates between 7:00 A.M. and 5:00 P.M. to be from 1:00 P.M. to 3:00 P.M. Running the dishwasher at this time also satisfies the user constraint of completing the wash cycle by 5:00 P.M., thus the smart energy component may run the dishwasher during this period.

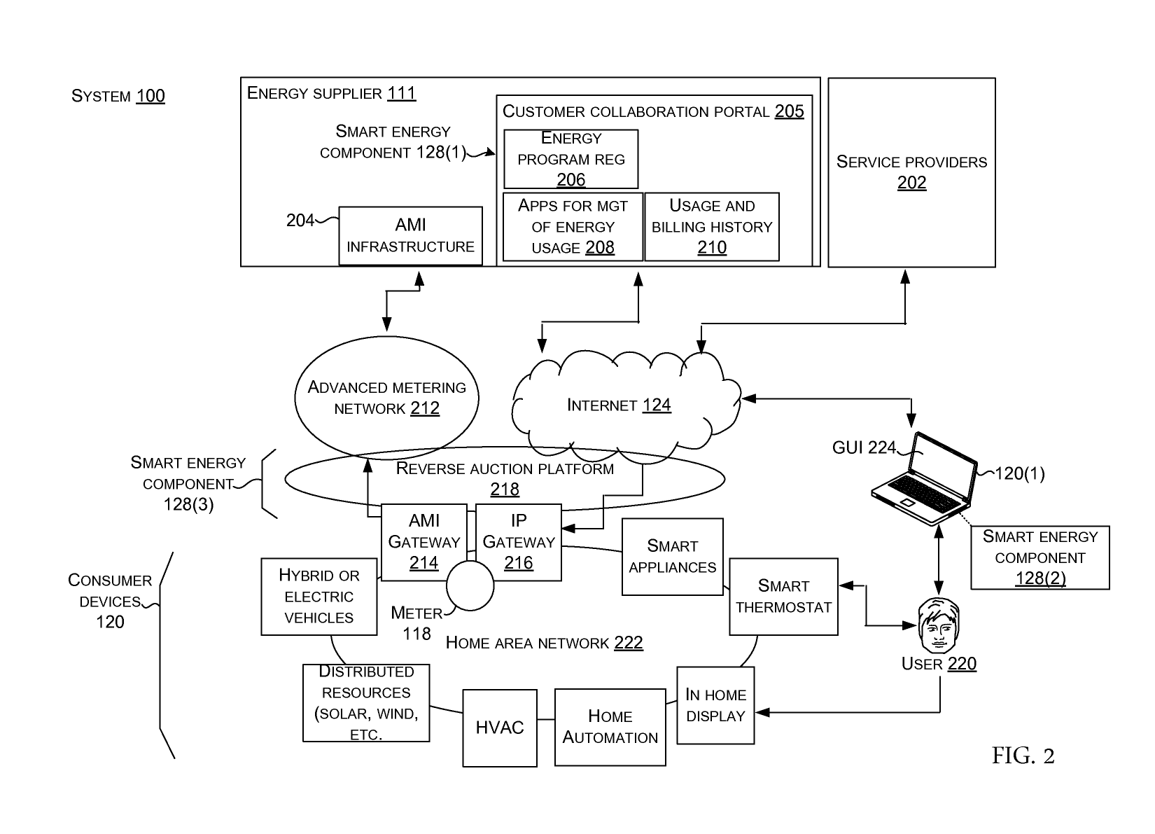

FIG. 2 shows another variation of system 100. In this case, the represented elements include energy suppliers 111 and/or and consumer devices 120. The energy suppliers 111 can include and/or work cooperatively with service providers 202. The service providers can provide energy supply related information that is available on the Internet 124 that can be useful for the reverse auction concepts. Further, the energy supplier 111 can include advanced metering infrastructure (AMI) 204 and an instance of smart energy component 128(1). AMI 204 can be thought of as infrastructure that supports smart electrical meters (or other devices) that measure more than simple consumption and an associated communication network to report the measurements.

In this case, the smart energy component 128(1) associated with the energy supplier 111 can provide a customer collaboration portal 205. The customer collaboration portal 205 can include energy program registration 206, applications for management of energy usage 208, and usage and billing history 210.

The energy supplier components can communicate with the consumer devices 120 via an advanced metering network 212 and/or the Internet 124. In this case, the illustrated consumer devices 120 can include hybrid or electric vehicles, distributed resources, HVAC, home automation, in home displays, smart thermostats, smart appliances, and/or a personal computer, among others. Some or all of the consumer devices can include an instance of the smart energy component (expressly shown as smart energy component 128(2) relative to consumer device 120(1)).

Communication with the consumer devices 120 can be facilitated by an AMI gateway 214 and/or an IP gateway 216. The communication can be channeled through the consumer's meter 118 or occur directly with the individual consumer devices 120 without meter involvement. For instance, the consumer devices 120 may be able to communicate via a local or home area network 222 that offers access to the Internet 124. This access can facilitate reverse auction platform 218 between the energy suppliers 111 and the consumer devices 120. The reverse auction platform 218 can be instantiated by an instance of the smart energy component 128(3). Further, the user or consumer 220 may be actively involved in energy related decisions via a graphical user interface presented on an individual consumer device, such as personal computer, a tablet, smart phone, etc.

The illustrated components can enable a reverse auction relating to individual consumer devices 120. For example, in one scenario, the smart energy component 128(3) could function as a facilitator between the energy suppliers 111 and the consumer devices 120 to accomplish the reverse auction. In another implementation, smart energy component 128(1) can interact with smart energy component 128(3) to accomplish the reverse auction. Still another implementation can be accomplished solely on the consumer devices by smart energy component 128(2).

In one implementation example, an individual energy supplier 111, such as an independent transmission operator may bargain or negotiate with an individual consumption device 120 to avoid having to buy expensive power or for other reasons, such as to avoid having to bring on additional non-renewable power generation resources. The reverse auction platform 218 can facilitate such bargaining. On the energy supply side, the AMI infrastructure 204 and/or the customer collaboration portal 205 can provide energy program registration, applications for management of energy usage, and/or customer usage and billing history. In some cases, the customer collaboration portal 205 can be enabled from/by the smart energy component 128(1). The energy supplier 111 can communicate over the advanced metering network 212 and/or the Internet 124.

An instance of the smart energy component 128, or multiple instances working cooperatively, can support a reverse auction platform 218 between the energy supplier 111 and the consumer devices 120. As mentioned, in some cases, the consumption side can include AMI gateway 214 and IP gateway 216 associated with the location's meter 118. The AMI infrastructure 204 and the AMI gateway 214 can handle communications between the supplier and the consumer devices at the customer location.

The reverse auction platform 218 can facilitate dispatching energy-consuming devices (e.g., individual consumer devices 120) based upon energy-related information, such as default device parameters, learned parameters, and/or consumers' established parameters for device performance in response to market signals (e.g., power prices or carbon emissions). The reverse auction platform 218 can aggregate device parameters and create a dispatch curve. The reverse auction platform can present dispatch curves to supply side entities (e.g., energy supplier 111), such as grid operators. The supply side entities can use the dispatch curve for grid planning.

Note also, that the reverse auction platform 218 can be applied to consumer devices 120 that can generate and/or store power, such as plug-in or hybrid cars, back-up power generators, etc. Stated another way, the suppliers can make it worthwhile for consumers to make extra power available under specific conditions. In real-time, the reverse auction platform can signal individual consumer devices 120 to adjust operations in accordance with grid conditions. For instance, the consumer's electric car could flow electricity from its batteries (e.g., until they reach a minimum of 80% capacity as defined by the user) at peak power cost times in the evening in exchange for twice the amount of power back from the supply side during the night, for example.

In some configurations, the consumer devices 120 can be connected via a local network, such as home area network 222. The local network can allow individual consumer devices 120 in the home to communicate with a hub like the user's personal computer 120(1), the user's smart phone, etc. Operational parameters can be established via a smart energy component 128 on the hub. For instance, some of the operational parameters can entail information about the consumer devices, such as how much power they consume when they run. Other operational parameters can entail operational history, such as what times of day does the consumer device tend to run. Once a new consumer device 120 is sensed on the home area network 222, the consumer 220 can be prompted to assign rules to the operation of the device, this can include hours of operations (e.g., porch light on from 9 P.M. to 5 A.M.) but also conditions under which standard operation should be optimized. These prompts can be based upon the actual cost structure from the local utility and would specify the potential cost or carbon savings associated with altered operations (e.g., prompt: may the supplier dim the lights by 50% if the price of electricity exceeds $X?). The consumer 220 can then be presented with the potential annual cost or carbon impact of optimized operation. Thus, graphical user interfaces can be presented to the user that let the user expressly decide reverse auction conditions and/or view default and/or passive conditions and then view the potential advantages (e.g., financial savings). Thus, the consumer 220 can see why they might want to participate and have higher confidence that they won't be unexpectedly inconvenienced.

The above described implementation is location specific (e.g., all of the consumer devices and the smart energy components are at the user's location (e.g. at the user's home). Some users may prefer the data control, privacy, and security offered by such a configuration. In other implementations, the smart energy component 128 can be remote, such as cloud-based, and communicate with the local consumer devices on the user's behalf. Also, in still other implementations, the smart energy component can operate on behalf of both the consumer and the energy supplier to ensure that each party receives benefits of the reverse auction concepts.

In some implementations, the supply side factors can involve surfacing a dispatch curve of consumer devices 120 enabling the grid operators to plan generation dispatch in response to likely consumer responses. Going forward this could allow supply side entities, such as utilities and grid operators to use these dispatch curves (or even projected curves that are developed based upon forecasts of consumer device uptake) to plan for (or avoid) future grid/generation upgrades. Presenting this information to grid operators along with surfacing true monetary value of smart consumer devices to consumers can reduce the deployment of redundant resources at the grid and consumer level.

Stated another way, being able to see the market price of power at individual times (e.g., power price-time profile) can allow money saving for the consumer. Thus, the suppliers could release power price-time profiles of market prices over time. This could decrease power usage when costs are high which could indirectly benefit the suppliers. Alternatively or additionally, to the power price-time profile, the supplier could make other information available. For instance, the supplier could have costs associated with spinning capacity or other reserve capacity that they do not recoup from the market. The suppliers could provide information that could decrease the amount of reserve capacity that they need to maintain. For instance, the information may indicate that if the consumer device guarantees not to run from 5:00 P.M. to 6:00 P.M. that it will receive a 50% rebate on power below market value on power used between midnight and 4:00 A.M. In such a case, both the consumer and the supplier can benefit in a way that is not directly reflected simply in the information about the power price-time profile. Thus, the present concepts can be thought of as enabling grid intelligent energy transactions at the consumer device level.

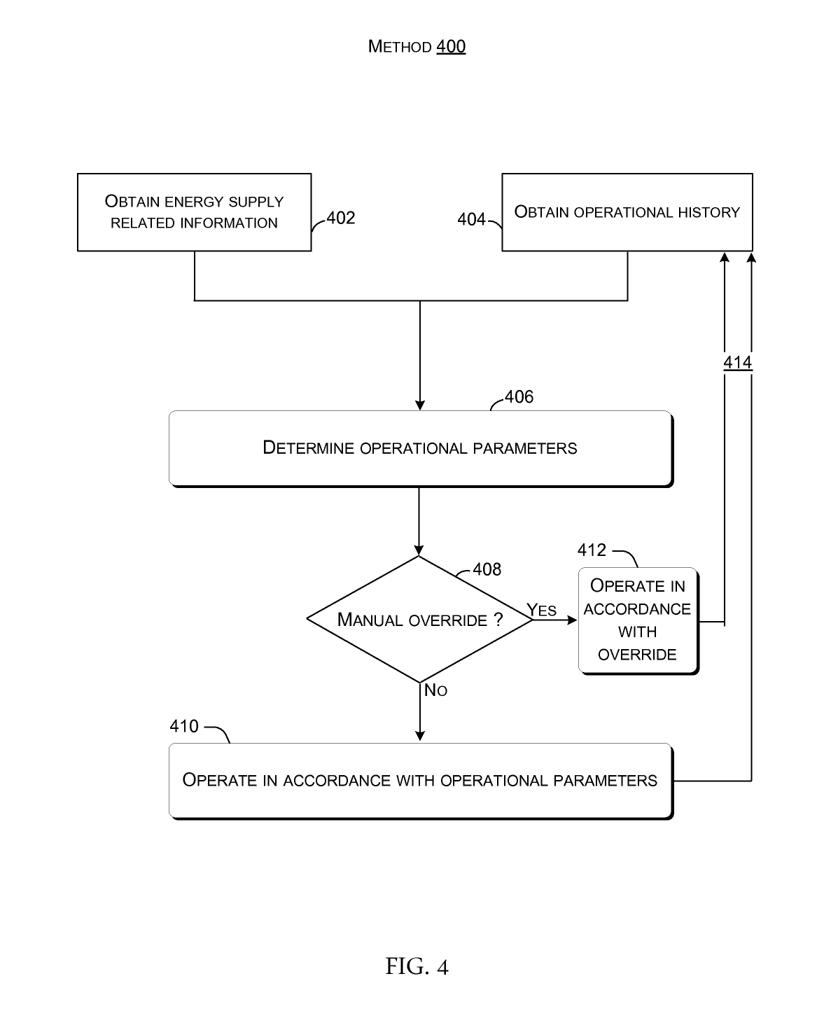

The reverse auction platform 218 can facilitate the ability to communicate information between the supply side energy suppliers 111 and the consumer devices 120 of the consumption side 104 (FIG. 1). The reverse auction platform can leverage algorithms that can match consumer device parameters with market conditions. Several such algorithms are described below relative to FIG. 4-6. This reverse auction platform can provide and/or support communication protocols between consumer devices 120 and the supply side 102 (FIG. 1). The reverse auction platform can support a consumer-facing application that can allow users to expressly define parameters for their consumer devices. For instance, the consumer-facing application can be manifest as a GUI 224 that can prompt users to set device operational parameters when a new consumer device (or an existing device) is connected to a network, such as home area network 222.

A value or advantage of the reverse auction platform 218 to the supply side energy supplier 111, such as a grid operator, can involve the aggregation of device consumption optionality into a dispatch curve. A value or advantage to the consumer 220 can be demonstrated in how well the reverse auction platform prompts present meaningful and logical optimizations and the degree to which savings are obtained (either in cost renewable profile, and/or carbon).

Stated another way, one value or advantage for the supplier can be to affect baseline consumer load (e.g. prior usage on a like day-weekday over 90 degrees, for instance). Real-time pricing at the small consumer level can alleviate much of this problem by providing clear signals for the cost savings associated with shifting usage from one period to another. Alternatively or additionally, the value to the consumer through cost savings and/or other advantages can cause the desired changes on the supply side and thus indirectly achieve the goals of the supply side. Part of the value of this system is that it can provide an incentive for supply side entities, such as utilities, to develop more granular rate designs at the small consumer level. The granular rate designs can be leveraged by the present implementations to the benefit of the consumer and the supplier.

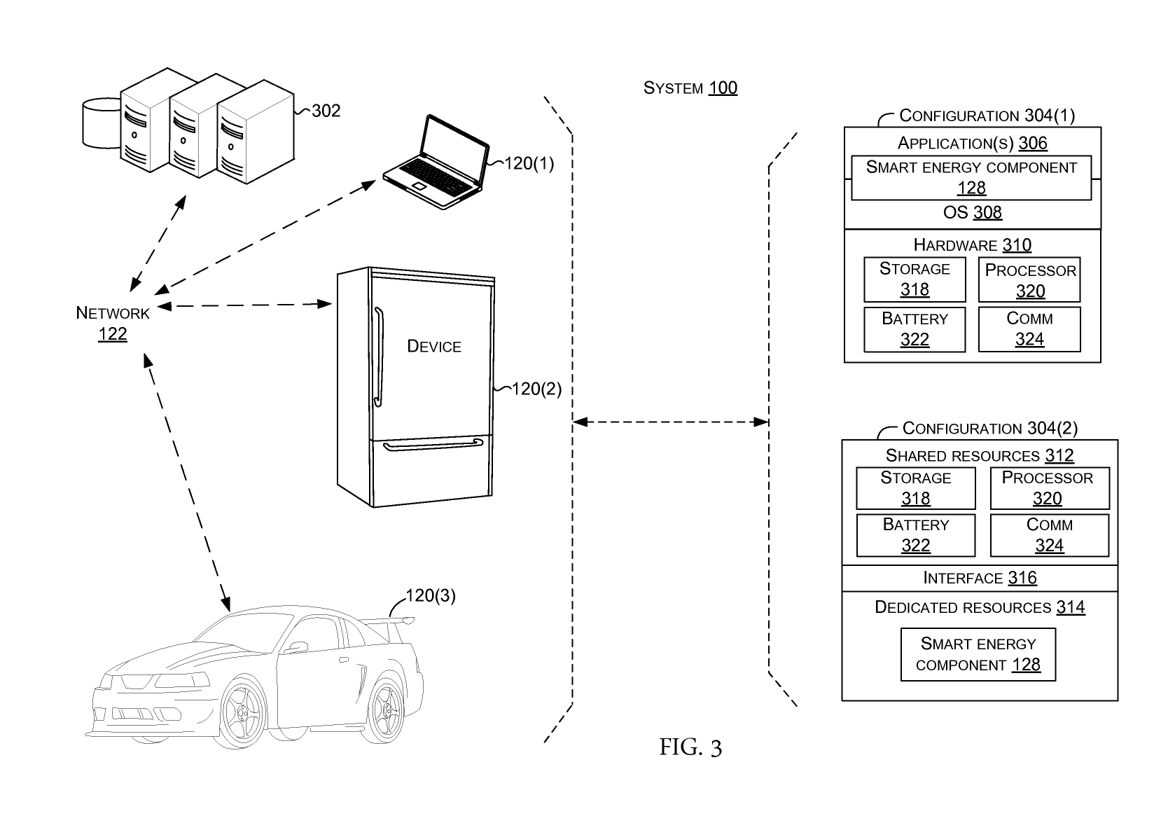

FIG. 3 shows an example variation of system 100 and associated example consumer devices 120(1), 120(2), and 120(3) as well as devices 302. Other example consumer devices are shown relative to FIGS. 1-2. In this case, device 302 is manifest as servers that can be cloud-based, can be controlled by an energy supplier (111 of FIG. 2) or controlled by a third party. The consumer devices 120 and/or devices 302 can facilitate energy transactions between the consumption side and the supply side (FIG. 1). The device examples shown in FIG. 3 are not meant to be limiting, any of a wide variety of types of devices could be included in an energy transaction system, such as energy transaction system that enables device specific reverse auctions. As shown in FIG. 3, any of the devices 120 and 302 can communicate over one or more networks.

FIG. 3 shows two device configurations 304. Individual devices, such as consumer devices 120 can employ either of configurations 304(1) or 304(2), or an alternate configuration. Briefly, configuration 304(1) represents an operating system centric configuration and configuration 304(2) represents a system on a chip (SOC) configuration. Configuration 304(1) is organized into one or more applications 306, operating system 308, and hardware 310. Configuration 304(2) is organized into shared resources 312, dedicated resources 314, and an interface 316 there between.

In either configuration 304, the device can include storage (e.g., computer-readable storage media) 318, a processor 320, a battery (or other power source) components 322, and/or a communication component 324. Either device configuration can also include a smart energy component 128.

The battery (or other power source) components (e.g. power control circuitry) 322 can include circuitry for tracking energy flow into (and/or out of the device). For instance, the battery component can track operational information relating to functioning of an individual consumer device 120, such as the charge level of the battery, the amount of energy stored in the battery, when the battery is charged (e.g., receives power) and discharged (emits power). In instances where the consumer device lacks a battery, the circuitry can track power usage and other operational information for the consumer device.

The communication component 324 can allow the consumer devices 120 and 302 to communicate with various other devices. The communication component 324 can include a receiver and a transmitter and/or other radio frequency circuitry for communicating via various technologies, such as cellular, Wi-Fi (IEEE 802.xx), Bluetooth, etc. The communication component can be configured to obtain operational information from the battery component 322 and supply side energy related information, such as pricing information from an external source, such as an energy supplier or a third party.

The smart energy component 128 can be configured to store energy related information on storage 318. The energy related information can include energy supply related information and energy that is available to the device and operational information about the consumer device such as how much energy the device takes to run. The smart energy component can determine operational parameters for the consumer device based upon the operational information and the energy related information. The smart energy component can be configured to monitor for a manual override from the user. Lacking a manual override (override command) from the user, the smart energy component can be configured to operate the consumer device in accordance with the operational parameters.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the computer. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, configuration 304(2) can be thought of as a system on a chip (SOC) type design. In such a case, functionality provided by the device can be integrated on a single SOC or multiple coupled SOCs. One or more processors 320 can be configured to coordinate with shared resources 312, such as memory, storage, etc., and/or one or more dedicated resources 314, such as hardware blocks configured to perform certain specific functionality. Thus, the term “processor” as used herein can also refer to central processing units (CPUs), graphical processing units (CPUs), controllers, microcontrollers, processor cores, or other types of processing devices.

Generally, any of the functions described herein can be implemented using software, firmware, hardware (e.g., fixed-logic circuitry), manual processing, or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

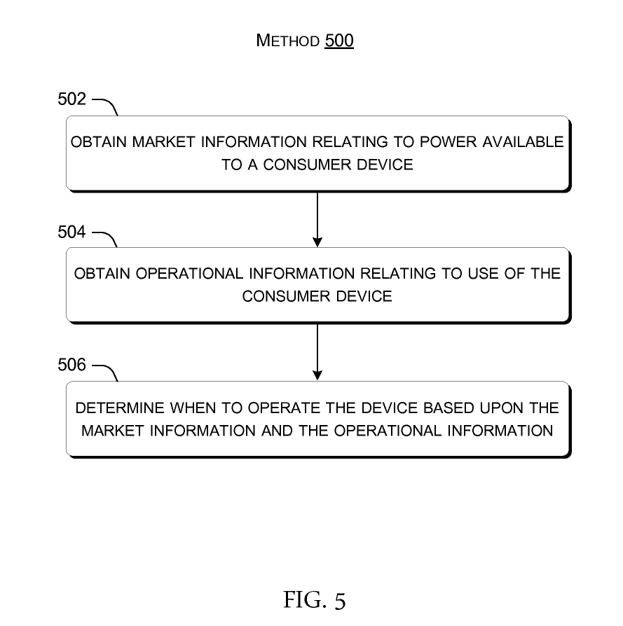

Some SOC configurations can employ an application specific integrated circuit (ASIC). For instance, some existing smart consumer devices, such as internet of things (IoT) devices can include an ASIC that includes instructions for operating the device, a microprocessor for executing the instructions and communication component, such as Bluetooth or Wi-Fi circuitry for communicating with other consumer devices. Some implementations can add additional smart energy instructions to the ASIC to allow energy aware device operation. For instance, the ASIC can include the smart energy component 128. For example, the ASIC can include logic gates and memory or may be a microprocessor executing instructions to accomplish the functionality associated with the smart energy component. Two such example instruction sets are described below relative to FIGS. 4 and 5.

### EXAMPLE TECHNIQUES

FIG. 4 shows an energy-aware flowchart of a method 400 that can be implemented by an individual consumer device 120 or on behalf of the consumer device, such as by a third party's smart energy component. A potential advantage of this implementation is that the method can be accomplished without exposing the user's information to other entities (e.g., can be performed on the individual consumer device and/or within the consumer devices of the user's home area network (222 of FIG. 2). Stated another way, the method can be accomplished in a manner that readily protects the user's privacy.

At block 402, the method can obtain energy supply related information. For instance, the energy supply related information can entail energy price information, such as 12 or 24 hour energy price-time profiles (e.g., an energy cost profile over time). The energy supply information can alternatively or additionally relate to the sources of the energy (e.g., at 1:00 P.M. 50% of the energy is coming from solar sources, at 4:00 P.M. 30% of the energy is coming from solar sources, at 7:00 P.M. 0% of the energy is coming from solar sources). In one configuration, the consumer device can obtain the energy pricing information from a website. Alternatively, the consumer device 120 may operate cooperatively with another consumer device belonging to the same consumer that can obtain the energy pricing information and act as a hub or master with the user's other consumer devices. For instance, the user's personal computer could function as the hub and share the energy pricing information with other consumer devices at the location using Wi-Fi, Bluetooth, or some other technology. In some cases, the energy pricing information can be obtained by accessing it from a web-site hosted by a supply side entity or a third party. In these cases, the IP address that accesses the content may be known to the supply side entity or third party, but other consumer and/or consumer device information need not be exposed.

At block 404, the method can obtain operational history of the consumer device. For instance, the device may store information about when it ran, power usage associated with running, user preferences, etc.

At block 406, the method can determine operational parameters for the consumer device based upon the energy supply related information and the operational history.

At block 408, the method can identify whether a manual override is received from the user. If no manual override is received (e.g., no at 408), the method can operate the consumer device in accordance with the operational parameters at 410. If a manual override is received (e.g., yes at 408) the method can operate the consumer device in accordance with the manual override at 412. Such a configuration can allow the user to control the consumer device when desired to avoid inconvenience to the user. In either circumstance, e.g. operating at 410 or 412, the operational information can be added to the operational history in a feedback loop at 414. Updating the operational history can allow the method to fine tune the operational parameters and ultimately increase user satisfaction and cost savings. Thus, this method can be accomplished while maintaining the user's privacy since it can be accomplished with one way data transfer (e.g., energy pricing information can be obtained in a one way data flow). User information such as information about the consumer devices and the operation of the consumer devices can be maintained at the location and need not be exposed to any external sources. In this example, the user (e.g., consumer) can directly benefit by reduced energy costs by reducing power usage at high cost times. The energy supplier can indirectly benefit by reduced need to produce expensive power and/or better matching of power supply and demand.

FIG. 5 shows another energy-aware flowchart of a method 500.

At block 502, the method can obtain market information relating to power available to a consumer device. The market information can entail energy price related information, such as a consumer price energy profile (e.g., an energy price over time profile). The consumer price energy profile can relate to a period of time and show market prices for the power at instances during the period of time. Alternatively or additionally, the energy profile can show source data for the power at the instances (e.g., x percent of the power at this time was generated using coal fired power plants and y percent of the power was generated with wind turbines). The source data can reflect the carbon emissions associated with the power, percentage of the power from renewable and non-renewable sources, etc. The market information can also include additional information that is not reflected in the market prices of the power. For instance, the market information could include incentives offered by suppliers for consumer devices to use power, not use power, and/or supply power at specific times. For instance, the power generator or distributer may be able to eliminate expensive spinning reserve capacity costs that it does not recover from the consumer market prices if it can affect consumer device behavior via the incentives. Stated another way, the additional information could relate to cost of production of individual increments of the power at individual times rather than cost to the consumer. Alternatively, the additional information could relate to financial incentives that the supply side entity is offering in exchange for specific usage behavior of individual consumer devices. For instance, on a given day, the supply side entity may have to buy expensive power on the open market to cover consumption needs from 5:00 P.M. to 6:00 P.M. The supply side entity might offer two free kilowatt hours of power from 11:00 P.M. to 4:00 A.M. to the individual consumer device for every kilowatt hour that the device would normally use, but abstains from using on that particular day.

At block 504, the method can obtain operational information relating to use of the consumer device. The operational information can relate to a usage history of the device, such as when it is used, how much power it uses, etc. The operational information can also entail information specifically provided by the user, such as ‘never interfere with use at these times,’ ‘must be at least 90% charged at this time,’ ‘try to use green power between these times,’ etc.

At block 506, the method can determine when to operate the device based upon the market information and the operational information. In some cases the determining can entail determining when to operate the device in a manner that saves money (financial incentive) and/or satisfies the usage information or the user defined information. For instance, the determining could consider saving the user money and satisfying green parameters (such as try to use green power if available for not more that 50% above market price) defined by the user.

In some cases, determining how to operate the device can entail determining when to operate the device and/or how to operate the device (e.g., at a percentage level). For example, the user may indicate that from 8:00 P.M. to midnight, lighting devices on the inside of the house have to operate at 100% brightness level if the user turns them on, but after midnight the lighting devices can be operated at a 50% level, whereas outside lights can be operated at 50% at any time.

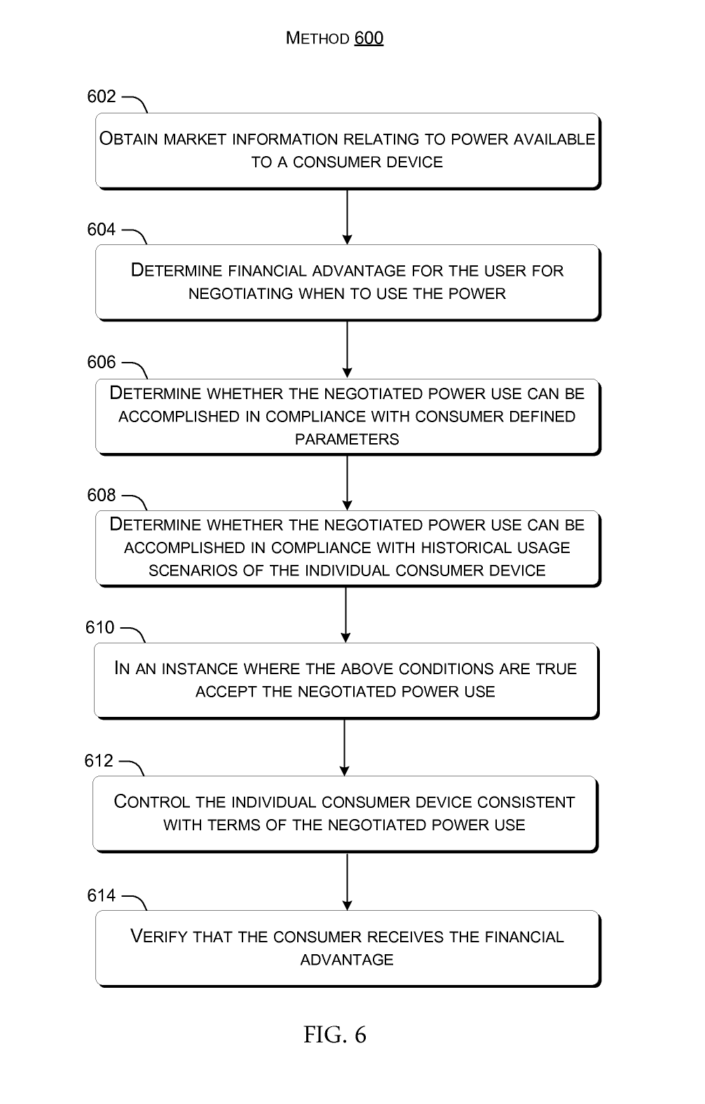

FIG. 6 illustrates a flowchart of a reverse auction energy transaction technique or method 600.

At block 602, the method can obtain market information relating to power available to a consumer device associated with a user.

At block 604, the method can determine financial advantage(s) for the user for negotiating when to use the power.

At block 606, the method can determine whether power use by the consumer device can be accomplished in compliance with consumer defined parameters for the consumer device.

At block 608, the method can determine whether the power use can be accomplished in compliance with historical usage scenarios of the individual consumer device.

At block 610, the method can in an instance where the above conditions are true (e.g., power use can be accomplished in compliance with the consumer defined parameters and the historical use), accept the negotiated power use (e.g., use the power consistent with terms of the negotiated power use).

At block 612, the method can control the individual consumer device consistent with terms of the negotiated power use.

At block 614, the method can verify that the consumer receives the financial advantage. The method can also verify to a supplier of the power that the individual consumer device was in fact operated in accordance with the negotiated power use. As such, the method can protect the interests of the energy consumer and the energy supplier.

The described methods can be performed by the systems and/or devices described above, and/or by other devices and/or systems. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on computer-readable storage media as a set of instructions such that execution by a processor of a computing device causes the computing device to perform the method.

### ADDITIONAL EXAMPLES

Various examples are described above. Additional examples are described below. One example is manifest as a consumer device that includes a communication component configured to obtain energy supply related information relative to powering the consumer device. The consumer device can also include storage including operational information of the consumer device. The consumer device can further include a smart energy component configured to determine operational parameters for the consumer device based at least in part upon the energy supply related information and the operational information. The smart energy component can be configured to monitor for a manual override from a user to control the powering of the consumer device. When the manual override is received, the smart energy component is configured to operate the consumer device in accordance with the manual override, otherwise the smart energy component is configured to operate the consumer device in accordance with the operational parameters.

Another example can be manifest as a combination of any of the above and/or below examples where the communication component, the storage, and the smart energy component are implemented on an application specific integrated circuit of the consumer device.

Another example can be manifest as a combination of any of the above and/or below examples further comprising a processor wherein the smart energy component comprises computer-readable instructions stored on the storage and executed by the processor.

Another example can be manifest as a combination of any of the above and/or below examples where the communication component is configured to obtain the energy supply related information from a website associated with a utility or a power generator.

Another example can be manifest as a combination of any of the above and/or below examples where the communication component is configured to obtain the energy supply related information from another consumer device associated with the user.

Another example can be manifest as a combination of any of the above and/or below examples where the energy supply related information comprises an energy cost profile over time.

Another example is manifest as a consumer device that includes storage including operational information of the consumer device and a communication component configured to obtain energy supply related information associated with a location of the consumer device. The consumer device can also include a smart energy component configured to determine operational parameters for the consumer device based at least in part upon the energy supply related information and the operational information The smart energy component can be further configured to operate the consumer device based at least in part upon the operational parameters and further configured to update the storage to reflect operation of the consumer devices while not exposing the operational information of the consumer device to entities that are external to the location.

Another example can be manifest as a combination of any of the above and/or below examples where the energy supply related information comprises a power price-time profile or wherein the energy supply related information comprises a renewable composition profile.

Another example can be manifest as a combination of any of the above and/or below examples where the communication component, the storage, and the smart energy component are manifest on an application specific integrated circuit (ASIC).

Another example can be manifest as a computer implemented method that can obtain market information relating to power available to a consumer device and can obtain operational information relating to use of the consumer device. The method can determine when to operate the device based upon the market information and the operational information.

Another example can be manifest as a combination of any of the above and/or below examples where the consumer device is associated with a consumer and wherein the obtaining market information is accomplished without exposing any information about the consumer to other entities.

Another example can be manifest as a combination of any of the above and/or below examples where the obtaining market information is accomplished without exposing any information about the consumer device to other entities.

Another example can be manifest as a combination of any of the above and/or below examples where the obtaining market information comprises one way data transfer from a third party to the consumer device or wherein the obtaining market information comprises two way data transfer between a third party to the consumer device.

Another example can be manifest as a combination of any of the above and/or below examples where the obtaining market information comprises obtaining additional information about the market information that is not reflected in market prices of the power.

Another example can be manifest as a combination of any of the above and/or below examples where the additional information relates to cost of production of individual increments of the power at individual times.

Another example can be manifest as a combination of any of the above and/or below examples where the obtaining operational information comprises obtaining usage information for the consumer device and obtaining user defined information for the consumer device.

Another example can be manifest as a combination of any of the above and/or below examples where the determining how to operate the consumer device comprises determining when to operate the consumer device in a manner that saves money for the consumer and satisfies the usage information or the user defined information.

Another example can be manifest as a combination of any of the above and/or below examples where the satisfying the user defined information is weighted higher than the saving money or the satisfying the usage information.

Another example can be manifest as a combination of any of the above and/or below examples where the determining how to operate the consumer device comprises determining when to operate the consumer device, or when the determining how to operate the consumer device comprises determining a level to operate the consumer device, or wherein the determining how to operate the consumer device comprises determining when to operate the consumer device and determining a level to operate the consumer device.

Another example can be manifest as a combination of any of the above and/or below examples performed by the consumer device or performed by another consumer device associated with a same user.

Another example can be manifest as a combination of any of the above and/or below examples performed by a third party that is not associated with the consumer device or supplying the power.

Another example can be manifest as a combination of any of the above and/or below examples further comprising operating the consumer device as determined unless an override command is received from a user.

Another example can be manifest as a combination of any of the above and/or below examples further comprising updating the operational information.

Another example can be manifest as one or more computer readable storage media having instructions stored thereon that when executed by a processor of a computing device cause the computing device to perform acts. The acts can include obtaining market information relating to power available to a consumer device associated with a user and determining a financial advantage for the user for negotiating when to use the power. The acts can further include determining whether power use by the consumer device can be accomplished in compliance with consumer defined parameters and determining whether the power use can be accomplished in compliance with historical usage scenarios of the consumer device. In an instance when the financial advantage is determined and the negotiated power use can be accomplished in compliance with the consumer defined parameters and the historical usage scenarios, accepting the negotiated power use. The acts can involve controlling the consumer device consistent with the negotiated power use and verifying that the user receives the financial advantage.

Another example can be manifest as a combination of any of the above and/or below examples where the market information comprises a power price-time profile or wherein the market information comprises a renewable composition profile.

Another example can be manifest as a combination of any of the above and/or below examples where the verifying further comprises verifying to a supplier of the power that the consumer device was operated consistent with terms of the negotiated power use.

Another example can be manifest as a combination of any of the above and/or below examples where the obtaining market information comprises obtaining an energy cost profile over time that relates to a period of time and shows market prices for the power at instances during the period of time and wherein the energy profile further shows source data for the power at the instances.

Another example can be manifest as a combination of any of the above and/or below examples where the obtaining market information comprises obtaining additional information about the market information that is not reflected in the market prices of the power.

Another example can be manifest as a combination of any of the above and/or below examples where the additional information relates to cost of production of individual increments of the power at individual times.

Another example can be manifest as a combination of any of the above and/or below examples where the obtaining operational information comprises obtaining usage information for the consumer device and obtaining user defined information for the consumer device.

Another example can be manifest as a combination of any of the above and/or below examples where the determining how to operate the consumer device comprises determining when to operate the consumer device in a manner that saves money for the consumer and satisfies the usage information or the user defined information.

Another example can be manifest as a combination of any of the above and/or below examples where satisfying the user defined information is weighted higher than the saving money or the satisfying the usage information.

Another example can be manifest as a combination of any of the above and/or below examples where the determining how to operate the consumer device comprises determining when to operate the consumer device, or when the determining how to operate the consumer device comprises determining a level to operate the consumer device, or wherein the determining how to operate the consumer device comprises determining when to operate the consumer device and determining a level to operate the consumer device.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A consumer device, comprising:
a communication component configured to obtain energy supply related information relative to powering the consumer device;
storage including operational information of the consumer device; and,
a smart energy component configured to determine operational parameters for the consumer device based at least in part upon the energy supply related information and the operational information, the smart energy component configured to monitor for a manual override from a user to control the powering of the consumer device, and when the manual override is received, the smart energy component is configured to operate the consumer device in accordance with the manual override, otherwise the smart energy component is configured to operate the consumer device in accordance with the operational parameters.

2. The consumer device of claim 1, wherein the communication component, the storage, and the smart energy component are implemented on an application specific integrated circuit of the consumer device.

3. The consumer device of claim 1, further comprising a processor, wherein the smart energy component comprises computer-readable instructions stored on the storage and executed by the processor.

4. The consumer device of claim 1, wherein the communication component is configured to obtain the energy supply related information from a website associated with a utility or a power generator.

5. The consumer device of claim 1, wherein the communication component is configured to obtain the energy supply related information from another consumer device associated with the user.

6. The consumer device of claim 1, wherein the energy supply related information comprises an energy cost profile over time.

7. A consumer device, comprising:
a communication component configured to obtain energy supply related information associated with a location of the consumer device;
storage including operational information of the consumer device; and,
a smart energy component configured to determine operational parameters for the consumer device based at least in part upon the energy supply related information and the operational information, the smart energy component further configured to operate the consumer device based at least in part upon the operational parameters and further configured to update the storage to reflect operation of the consumer devices while not exposing the operational information of the consumer device to entities that are external to the location.

8. The consumer device of claim 7, wherein the energy supply related information comprises a power price-time profile or wherein the energy supply related information comprises a renewable composition profile.

9. The consumer device of claim 7, wherein the communication component, the storage, and the smart energy component are manifest on an application specific integrated circuit (ASIC).

10. A computer implemented method, comprising:
obtaining market information relating to power available to a consumer device;
obtaining operational information relating to use of the consumer device; and,
determining how to operate the device based upon the market information and the operational information.

11. The method of claim 10, wherein the consumer device is associated with a consumer and wherein the obtaining market information is accomplished without exposing information about the consumer to other entities.

12. The method of claim 10, wherein the obtaining market information is accomplished without exposing information about the consumer device to other entities.

13. The method of claim 10, wherein the obtaining market information comprises one way data transfer from a third party to the consumer device or wherein the obtaining market information comprises two way data transfer between a third party and the consumer device.

14. The method of claim 11, wherein the obtaining market information comprises obtaining additional information about the market information that is not reflected in market prices of the power.

15. The method of claim 14, wherein the additional information relates to cost of production of individual increments of the power at individual times.

16. The method of claim 10, wherein the obtaining operational information comprises obtaining usage information for the consumer device and obtaining user defined information for the consumer device.

17. The method of claim 16, wherein the determining how to operate the consumer device comprises determining when to operate the consumer device in a manner that saves money for the consumer and satisfies the usage information or the user defined information.

18. The method of claim 17, wherein satisfying the user defined information is weighted higher than the saving money or the satisfying the usage information.

19. The method of claim 16, wherein the determining how to operate the consumer device comprises determining when to operate the consumer device, or when the determining how to operate the consumer device comprises determining a level to operate the consumer device, or wherein the determining how to operate the consumer device comprises determining when to operate the consumer device and determining a level to operate the consumer device.

20. The method of claim 10, performed by the consumer device or performed by another consumer device associated with a same user.
